(19) United States
(12) Patent Application Publication
(10) Pub. No.: US 2018/0045646 A1
(43) Pub. Date: Feb. 15, 2018

(54) SYSTEM AND METHOD FOR THREE-DIMENSIONAL MICRO PARTICLE TRACKING

(71) Applicant: National Taiwan Ocean University, Keelung (TW)

(72) Inventors: JYH-JONG SHEEN, Keelung (TW); Tzu-Ching Yeh, Keelung (TW); Yin-Hsuan Huang, Keelung (TW); Hung-Hsiang Chien, Keelung (TW)

(21) Appl. No.: 15/236,643

(22) Filed: Aug. 15, 2016

(51) Int. Cl. G01N 21/64; G01N 15/14

(52) U.S. Cl. CPC G01N 21/6456; G01N 15/1459; G01N 15/1434; G01N 2015/1075

(57) ABSTRACT

The present invention provides system and method for three-dimensionally tracking micro particle motion wherein a dark-field condenser is configured to receive light field emitted from a light source and project the light field on a fluid sample having at least one particle thereby generating a scattered light field associated with the at least one particle, an objective lens is configured to receive the scattered light field, an image capturing unit coupled to the objective lens receives the scattered light field thereby generating at least one image of the fluid sample, and a controller is configured to couple to the image capturing unit for analyzing interference ring pattern corresponding to a specific particle in the at least one image and determining a tracking information associated with the specific particle along three-dimensional direction according to the size and center of the interference ring pattern.

### BACKGROUND OF INVENTION

### 1. Field of the Invention

The present invention relates to a system and method for tracking particle and, more particularly, to a system and method for three-dimensionally tracking micro particle motion within a fluid.

### 2. Description of the Prior Art

Particle image velocimetry (PIV) is a technique for measuring the velocity of the particle within a fluid. Unlike the conventional measuring method and system, the PIV technique can accurately measure high resolution velocity fields without using intrusive manner to interfere the fluid motion thereby causing an inaccurate result. Accordingly, the PIV technique can be applied in microfluidic devices utilized for performing tests of fluidic samples, such as fluids in microfluidic biochip, for example.

In order to accurately monitor the velocity field of particle motion in the microfluidic devices, there has a need of three-dimensionally tracking particle motion within the fluid sample in the microfluidic devices. Although conventional PIV technique, such as micro-PIV, can be utilized to track the particle motion, it can only track two-dimensionally motion of the particle.

In order to provide three-dimensional particle tracking, one conventional method called defocusing method is utilized to use defocusing in conjunction with a mask (three pin holes) embedded in the camera lens to decode three-dimensional point sources of light (i.e., illuminated particles) on a single image. The sizes and locations of the particle image patterns on the image plane relate directly to the three-dimensional positions of the individual particles. Using sequential images, particles may be tracked in space and time.

In addition, another conventional method called image aberration method is utilized to modify the particle image by placing a cylindrical lens in between the microscope and camera. The cylindrical lens deforms the particle image into an ellipse where the major and minor axis length difference provides information on the depth of the particle so as to establish three-dimensional particle tracking information. Alternatively, Massimiliano Rossi et al. (2010) disclosed a study on the defocusing of tracer particles and the DOC (depth of correlation) related bias error present in micro-PIV measurements. Rossi shows that the DOC predicted using the conventional formulas can be significantly smaller than its actual value so that Rossi proposed the use of an effective NA determined experimentally from the curvature of the image autocorrelations.

The defocusing method and image aberration method are not suitable for broad range measurement because these methods have low signal-to-noise (S/R) ratio caused by insufficient luminous flux. Regarding the method proposed by Rossi, it can have accurate measurement under lower magnification image whereas measurement under high magnification image is inaccurate. This is because the image variation with respect to different depth is determined according to image magnification, size of diffraction image and size of defocusing image.

In order to improve the drawbacks of the aforementioned conventional method for three-dimensionally tracking the particle motion, US. Pub. No. 20140160266 provides an image resolution enhancement techniques using a single image an unstructured broadband illumination. By placing an axicon and a convex lens pair in an optical path of a microscope, telescope, or the object system, between the system and an image capture pickup device (e.g., a camera) the maximum resolution of the system may be increased through the formation of an interference pattern at the image capture device. The Fresnel diffraction integral is applied to show that a paraxial point source produces a Bessel beam. A simple analytical relationship is demonstrated between the location of the point source and the spatial frequency and the center of the resulting Bessel beam in the image plane of a camera. The resulting images are then analyzed to predict the location of the point source with excellent accuracy. Although Snoeyink can accurately measure the tracking information along depth direction (vertical direction), the distance for forming an image after the light passing the axicon is 20 cm or above such that it will be complicated to adjust the optical path and optical system configuration.

Accordingly, there has a need for providing a system and method for tracking particle within a fluid along the vertical direction.

### SUMMARY OF THE INVENTION

The present invention provides a system and method for three-dimensionally tracking a particle motion where the measurement errors are reduced and information-noise ratio of the image is greatly improved simultaneously. In addition, the present invention can capture the interference image of particles within the fluid sample by utilizing a consumer electronic camera such that not only the cost of the system is greatly reduced, but also the signal noise is eliminated so as to increase the S/R ratio. In addition to the consumer electronic camera, alternatively, high-speed camera can also be another embodiment for capturing interference image.

The present invention provides a system and method for three-dimensionally tracking a particle motion, in which a dark-field condenser lens is utilized to projecting a light field on a fluid sample having at least one particle, whereby a scattered light associated with the at least one particle is generated and captured by image capturing unit thereby generating at least one image having an interference ring pattern associated with the at least one particle. When the image is obtained, the two-dimensional particle tracking, i.e, velocity field or position on XY plane perpendicular to the optical axis of the objective can be obtained according to the known techniques. The present invention further provides a measure to obtain tracking information of specific particle along the vertical direction, wherein according to the linear relationship between the size of the interference ring pattern corresponding to each particle's vertical position, i.e., position along direction parallel to the optical axis of objective, the vertical position of a specific particle can be determined according to the size of the interference ring pattern shown in one single image. Furthermore, a vertical velocity, i.e., velocity along direction parallel to the optical axis of objective, can be also determined according to two consecutive images with respect to different time point of the captured images. Accordingly, the three-dimensional particle tracking can be achieved.

In one embodiment, the present invention provides a particle tracking system, comprising a light source, a dark-field condenser lens, an objective lens, an image capturing unit, and a controller. The light source is configured to generate a light field. The dark-field condenser lens is configured to receive the light field and project the light field on a fluid sample having at least one particle thereby generating a scattered light field associated with the at least one particle. The objective lens is configured to receive the scattered light field. The image capturing unit is configured to couple to the objective lens for receiving the scattered light field thereby generating at least one image corresponding to the scattered light field. The controller is configured to couple to the image capturing unit for analyzing an interference ring pattern corresponding to a specific particle in the at least one image and determining a tracking information associated with the specific particle along a vertical direction according to the size of the the interference ring pattern.

In another embodiment, the present invention provides a method for tracking particle, comprising steps of providing a light field generated by a light source, providing a dark-field condenser lens for receiving the light field and projecting the light field on a fluid sample having at least one particle thereby generating a scattered light field associated with the at least one particle, receiving the scattered light field by an objective lens, acquiring at least one image of the fluid sample by an image capturing unit coupled to the objective lens, and analyzing the interference ring pattern corresponding to a specific particle in the at least one image and determining a tracking information associated with the specific particle along a vertical direction by a controller electrically coupled to the image capturing unit.

All these objects achieved by the system and method for tracking particle motion within a fluid along a vertical direction are described below.

### BRIEF DESCRIPTION OF THE DRAWINGS

The present invention will now be specified with reference to its preferred embodiment illustrated in the drawings, in which:

FIG. 1 illustrates a system for tracking particle motion according to one embodiment of the present invention.

FIG. 2 illustrates off-axis illumination on the fluid sample and the image capturing unit captures the scattered light from the particles within the fluid sample.

FIG. 3 illustrates one embodiment of generating an interference ring pattern when a particle is illuminated by an off-axis incident light field from dark-field condenser lens.

FIG. 4 illustrates one embodiment of method for tracking particle motion according to the present invention.

FIGS. 5 and 6 are illustrated to explain the linear relationship between the size of the interference ring pattern corresponding to a specific particle and its different vertical position.

FIG. 7 illustrates one embodiment of flow chart for determining the size and center of the interference ring pattern corresponding to one specific particle moved along the vertical direction.

FIGS. 8A and 8B respectively illustrate three or two dimensional peak value of the outermost ring of the interference ring pattern.

FIG. 9 illustrates the result of determining the size and center of the interference ring pattern according to the flow shown in FIG. 7.

FIG. 10 illustrates the exact solution curve and experimental result of the velocity distribution along the vertical direction with respect to a laminar flow passing through circular microfluidic channel wherein the experimental result is obtained through the method and system of the present invention.

### DESCRIPTION OF THE PREFERRED EMBODIMENT

The invention disclosed herein is directed to a system and method for tracking particle motion along vertical direction, i.e. direction parallel to the optical axis of objective. In the following description, numerous details corresponding to the aforesaid drawings are set forth in order to provide a thorough understanding of the present invention so that the present invention can be appreciated by one skilled in the art, wherein like numerals refer to the same or the like parts throughout.

Although the terms first, second, etc. may be used herein to describe various elements, components, modules, and/or zones, these elements, components, modules, and/or zones should not be limited by these terms. Various embodiments will now be described in conjunction with a number of schematic illustrations. The embodiments set forth a system and method for tracking particle motion along vertical direction than conventional approaches. Various embodiments of the application may be embodied in many different forms and should not be construed as a limitation to the embodiments set forth herein.

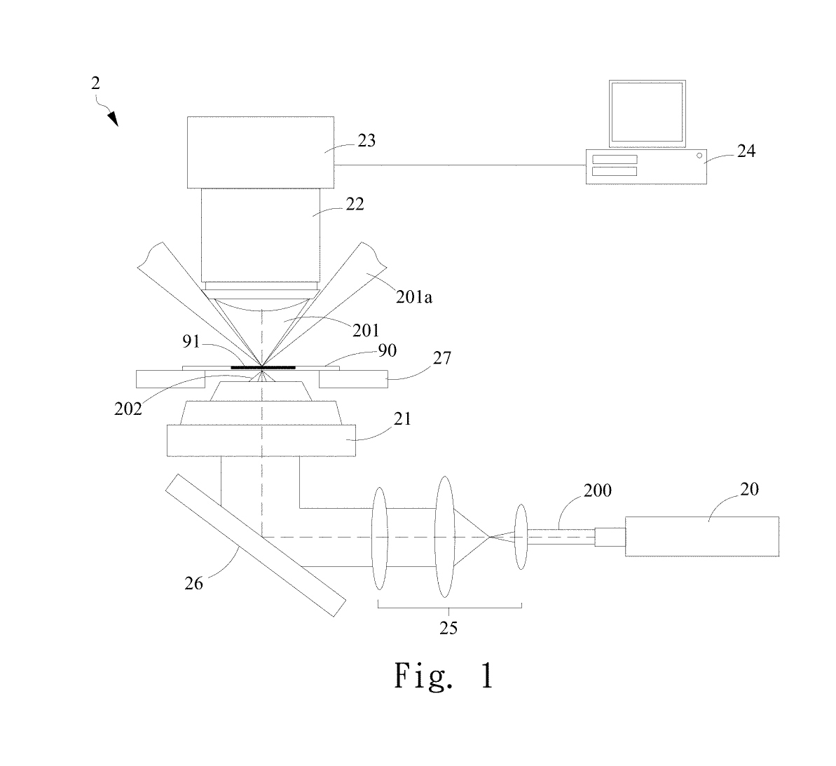

Please refer to FIG. 1, which illustrates system for tracking particle motion according to one embodiment of the present invention. In the embodiment shown in FIG. 1, the system 2 comprises a light source 20, a dark-field condenser lens 21, an objective lens 22, an image capturing unit 23, and a controller 24. The light source 20 is configured to generate a light field 200. It is noted that the light source 20 can be a laser beam generator for generating a laser beam as the light field. Alternately, the light source 20 can also be a LED light source for generating LED light as the light field. In addition, the light source 20 can also be an invisible light source, such as UV light source. In the embodiment of LED light source, preferably, a polarizer is utilized to filter the LED light for enhancing optical interference effect. It is noted that there has no specific limitation on the color of the light field. It can be a color light field or white light field. In the present embodiment, the light source is the laser beam generator for generating a green laser beam. A lens module 25 having a plurality of lens including focusing lens, beam expander, and neutral density (ND) filter is arranged between the dark-field condenser lens 21 and light source 20. The light field 200 is focused by the focusing lens, and then expanded by the beam expander. Finally, the light intensity of the expanded light beam is reduced intensity by the ND filter. The light field passing through the lens module 25 is further reflected to the dark-field condenser lens 21 through a reflector 26.

The dark-field condenser lens 21 is configured to receive the light field 200 from the lens module 25 and provide an off-axis illumination on a microfluidic chip 90 having a fluid sample 91 with at least one particle whereby a scattered light field 201 associated with the at least one particle and off-axis light field 201a passing directly through the fluid sample 91 are generated. The dark-field condenser lens 21 is arranged between the light source 20 and the sample fluid 91. In the present embodiment, it is arranged under the support stage 27 where the microfluidic chip 90 is located. The fluid sample 91, in the present embodiment, is arranged in a microfluidic channel formed on the microfluidic chip 90. The microfluidic chip 90 is arranged on the support stage 27 above the dark-field condenser lens 21. The dark-field condenser lens 21 receives the light field and generates the received light field into a cone-shaped light 202 and finally, projects the cone-shaped light 202 to the sample fluid 91 whereby the particles within the fluid sample scatter the light field toward the direction where the objective lens 22 is arranged.

The objective lens 22 is configured to receive the scattered light field 201 emitted by the particles while the off-axis light field 201a will not enter the objective lens 22. The image capturing unit 23 is coupled to the objective lens 22 for receiving the scattered light field 201 thereby generating at least one image associated with the fluid sample. In the present embodiment, the image capturing unit 23 can be a monochrome CCD or a consumer electronic camera depending on user's need. In the present embodiment, the image capturing unit 23 is digital single-lens reflex camera (DSLR), such as Cannon EOS 5D Mark II. It is noted that the DSLR camera is not limited to the aforementioned type, and it can be decided according to user's requirement. The image has at least one interference ring pattern corresponding to the particles within the scope of the objective lens 22, wherein the interference ring pattern has a plurality of concentric rings. Alternatively, the image capturing unit 23 can also be a high-speed camera or three-CCD Camera. It is noted that the camera can be a color camera or mono camera.

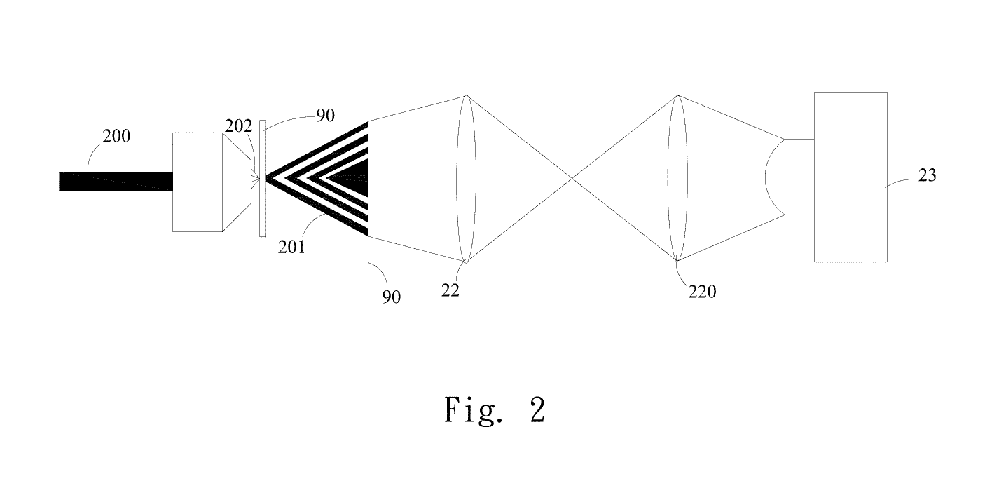

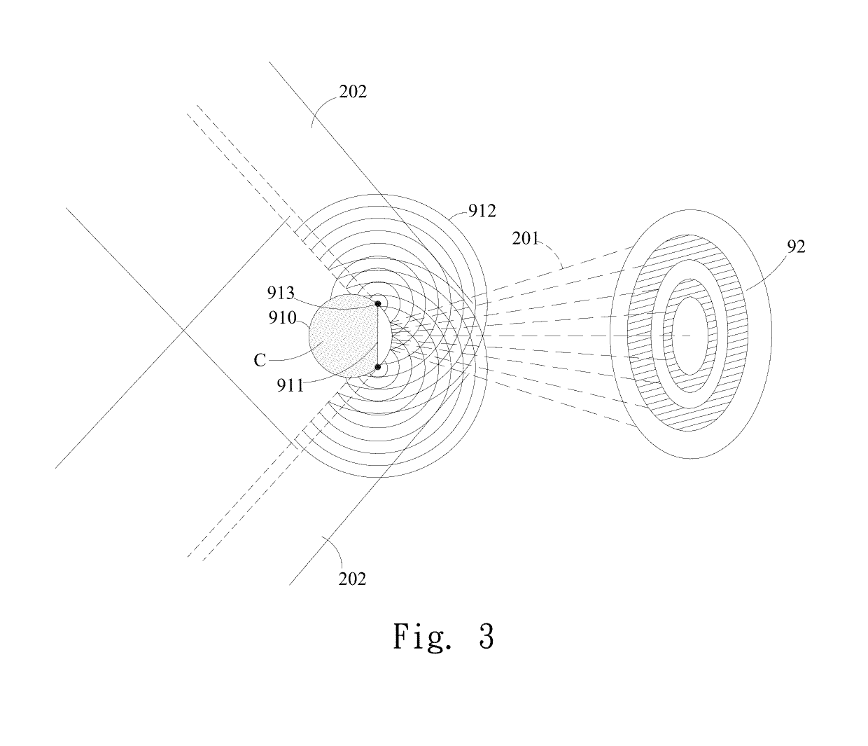

Please refer to FIG. 2 and FIG. 3, which illustrate the phenomenon for generating an interference ring pattern of each particle. In the present embodiment, the dark-field condenser lens 21 generates off-axis illumination effect where the light field 200 passing through the dark-field condenser lens 21 will project onto the microfluidic chip 90 with oblique angle (cone-shaped light). The cone-shaped light field 202 projects on the particle 910 in the fluid sample such that the periphery of each particle 910 projected by the light field 202 will generate an illuminated area C. Please refer to the FIG. 3 for detail, wherein the particle 910 is projected by the off-axis light filed 202 from the dark-field condenser lens 21, whereby the dotted area at left side of the annular line 911 illuminated by the off-axis light field 202 is defined as the illuminated area C. The illuminated area C can be considered as three-dimensionally distributed point light sources such as point light source 913, for example, on the particle surface, each of which emits spherical waves 912. When the illuminated particle is not on the image plane of the microscope, these spherical waves 912 interfere with each other and generate an interference ring pattern on the image plane of the microscope. Unlike the Bessel interference ring patterns that the optical intensity is decreased from the inner rings to the outermost ring, the interference ring pattern of the present embodiment is different from the Bessel interference ring pattern because the outermost interference ring is brighter than the inner interference ring due to the fact that there are more waves coming from left region of the illuminated area C in FIG. 3 for the outermost ring. The scattered light field 201 having interference ring patterns is received by the objective lens 22 and is captured by the image capturing unit 23 coupled to the eyepiece 220 of the objective lens 22 thereby an interference-ring image can be obtained.

Please refer back to the FIG. 1, the controller 24 is configured to couple to the image capturing unit 23 and receives the images captured by the image capturing unit 23. The number of captured images is depending on the number of on/off operation of shutter in the image capturing unit 23. After the controller 24 receives the images captured by the image capturing unit 23, the controller 24 analyzes the received image, acquires an interference ring pattern corresponding to a specific particle in the image and determines a tracking information associated with the specific particle along a vertical direction. In the present embodiment, the vertical direction refers to the direction parallel to the optical axis of objective. The tracking information may be a position or a velocity along the vertical direction. The controller 24 can be a device having signal operation and processing capability such as computer or server, for example.

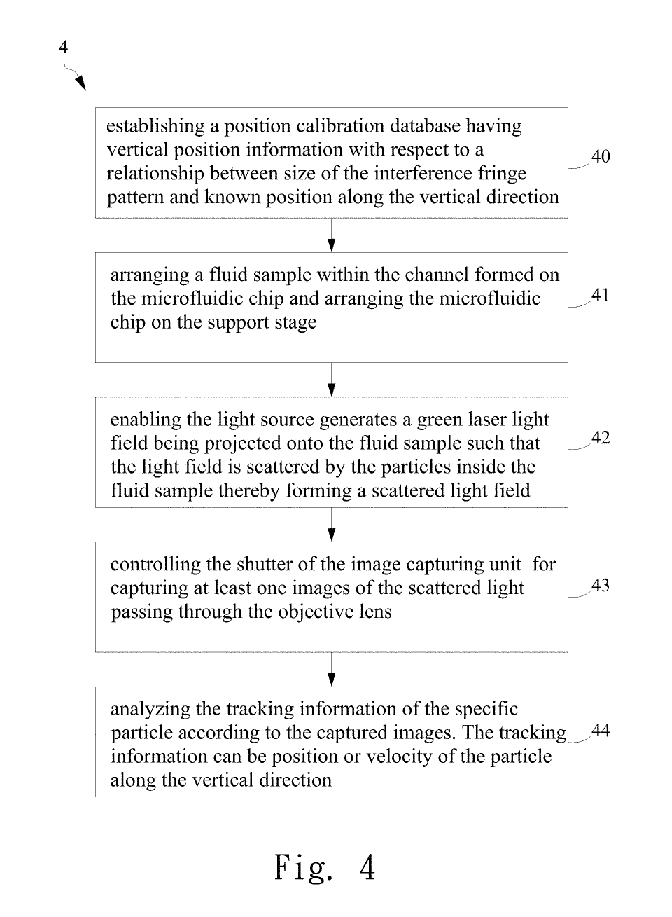

Please refer to the FIG. 4, which illustrates one embodiment of method for tracking particle motion according to the present invention. At the first step 40, a linear relationship between size of the interference ring pattern and known positions along the vertical direction is established and stored in a memory or storage unit built in the controller 24 or computer electrically coupled to the controller 24. In this step, the microfluidic chip 90 comprising fluidic channel is arranged on the support stage 27 shown in FIG. 1. In the step 40, in order to establish the data between the depth position and size of the interference ring pattern, the particle samples having known size can be arranged on the bottom channel wall, and top channel wall of the fluidic channel formed on the microfluidic chip. It is noted that the size of particle sample can be selected depending on the user's need. Then, like the configuration shown in FIG. 1, the light field 200 generated from the light source 20 is projected on the particle samples arranged on the top and bottom channel wall through the dark-field condenser lens 21. Next, the images of the particle samples on the bottom and top channel walls are captured. After that, the controller 24 analyzes the images and determines the size of the interference ring patterns respectively corresponding to the particle samples on the top and bottom wall of the channel. Since the size of the interference ring pattern has linear relationship with the vertical position inside the fluidic channel and the channel width between the top and bottom channel walls is known, the sizes of the interference ring patterns with respect to the particle samples on the top and bottom channel walls can be utilized to establish the linear position calibration curve of vertical position inside the channel. It is also noted that since the inspection range of the vertical direction inside the fluidic channel is related to the intensity of the light field, it further comprises a step of adjusting the power of the light source for increasing an intensity of the light field thereby increasing an inspection range of the vertical direction inside the fluidic channel.

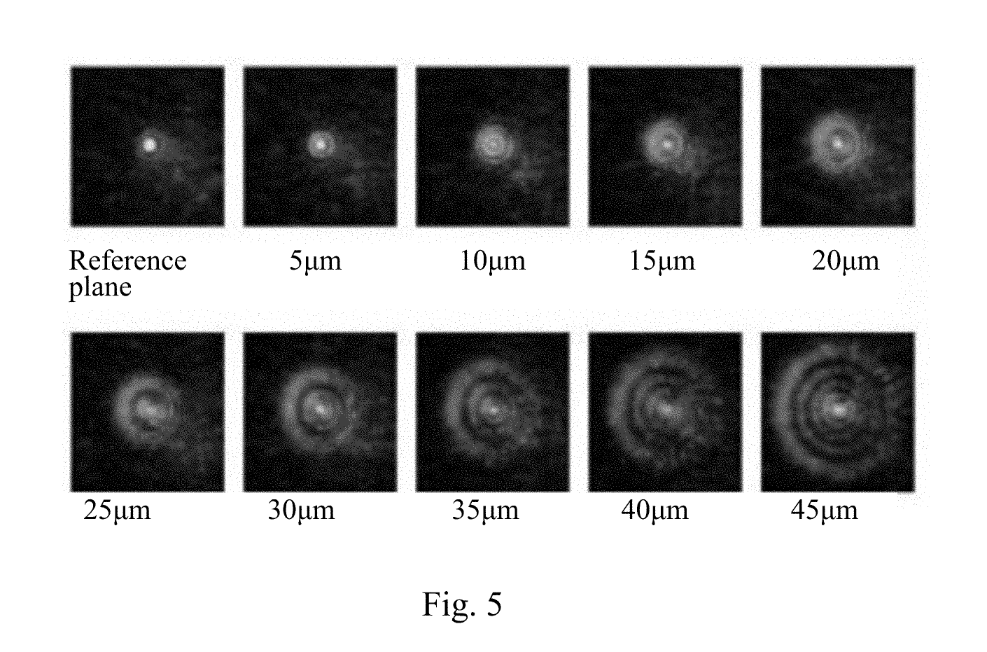

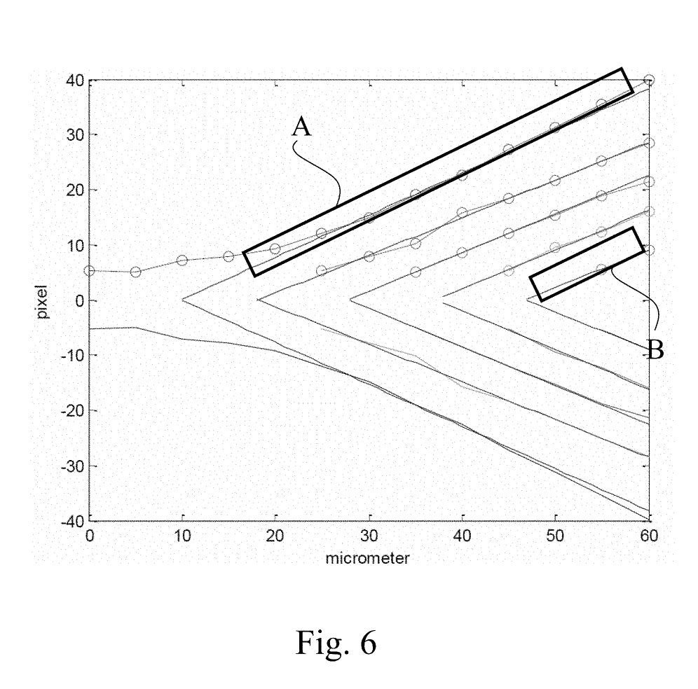

Please refer to FIGS. 5 and 6, which illustrate to explain the linear relationship between the size of the interference ring pattern corresponding to a specific particle and its different vertical position. In the FIG. 5, the original particle size is 1 μm and it is noted that the size of the interference ring pattern of the specific particle is getting larger and larger when the particle position is changed from the image plane to the deeper position in the fluidic channel along the vertical direction. For example, the size of the interference ring pattern at depth of 45 μm is larger than the size of the interference ring pattern at depth of 10 μm. According to the size of the interference ring pattern and know vertical position, FIG. 6 can be drawn so as to show the linear relationship between the size of the interference ring pattern and different vertical position, wherein the horizontal axis represents depth position of the fluidic channel along the direction parallel to the optical axis of the objective while the vertical axis represents the size of the interference ring pattern. The area A shows the outermost bright ring of each interference ring pattern while the area B shows the innermost bright ring of each interference ring pattern. It is noted that the linear relationship is clearly shown for each ring of the interference ring pattern according to FIG. 6. Since the outermost bright ring has broader inspection range along the vertical direction than the other bright rings; therefore, the size of the outermost ring is more appropriate to be utilized to establish the linear relationship between the size of interference ring pattern and vertical position.

After establishing the linear relationship, please refer to FIG. 1 and FIG. 4, step 41 is performed to arrange a fluid sample within the channel formed on the microfluidic chip 90 and arrange the microfluidic chip 90 on the support stage 27. After that, step 42 is performed to enable the light source 20 to generate a green laser light field and project the light field onto the fluid sample 91 such that the light field is scattered by the particles inside the fluid sample 91 thereby forming a scattered light field 201. Next, the step 43 is performed to control the shutter of the image capturing unit 23 for capturing at least one images of the scattered light field 201 passing through the objective lens 22. It is noted that although the color of light field in step 42 is a green light field, it is only an embodiment for exemplary explanation. Other color light, such as red or blue color, can also be utilized as an incident light field.

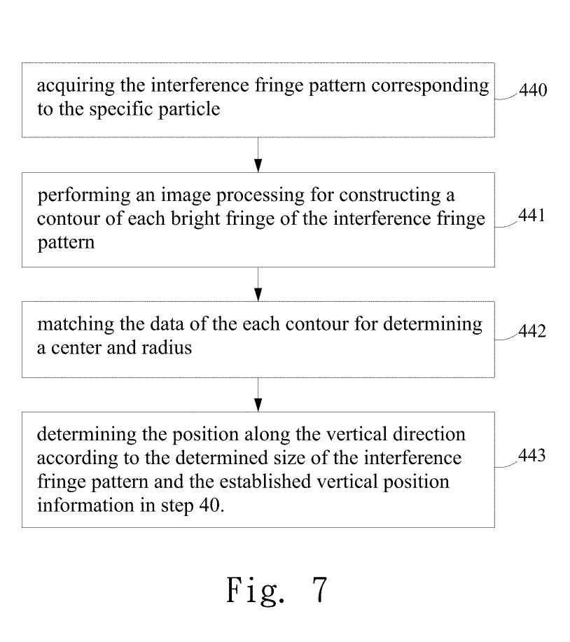

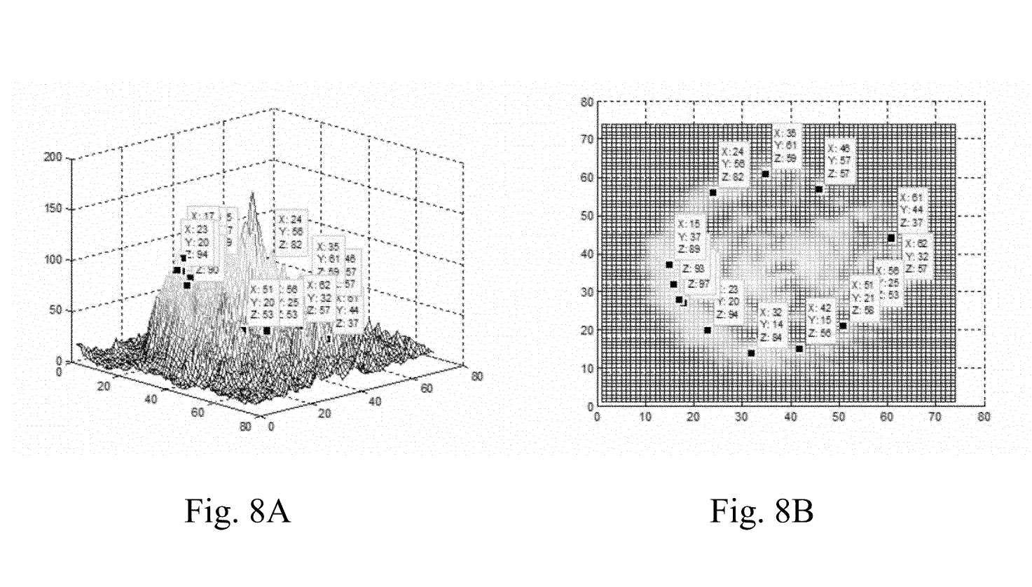

When the images with respect to the fluid sample are captured, step 44 is performed to analyze the tracking information of the specific particle according to the dimension of the corresponding particle shown in the captured images. The tracking information can be position or velocity of the particle along the vertical direction. In case of determining the position of the specific particle along the vertical direction, the controller 24 analyzes a single image having an interference ring pattern of the specific particle. In the embodiment of this step 44, it further comprises steps shown in FIG. 7. At first, step 440 is performed wherein the controller 24 acquires the interference ring pattern corresponding to the specific particle from the image captured by the image capturing unit 23. Next, step 441 is performed wherein the controller 24 performs an image processing for constructing a contour of each bright ring of the interference ring pattern. In one embodiment of step 441, the controller 24 can execute software, for example, to construct a two or three dimensional contour of the interference ring pattern. After constructing the contour, the peak values of the contour representing the outermost ring are also calculated. One embodiment for showing the peak values of the outermost ring is illustrated as FIGS. 8A and 8B.

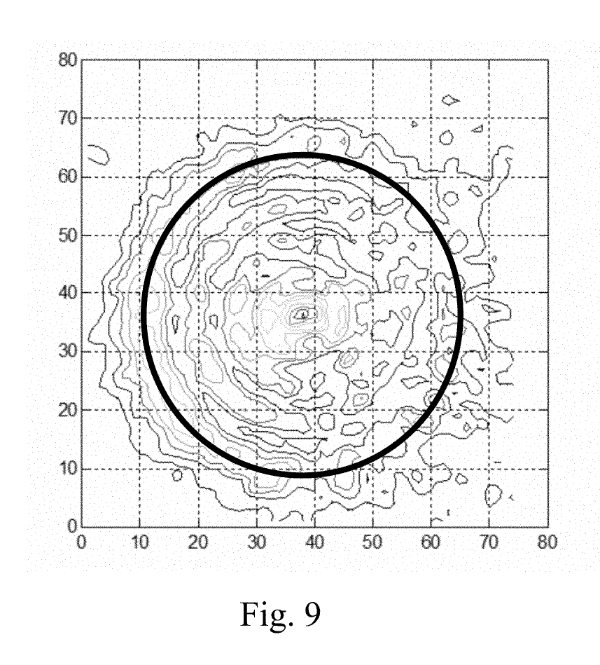

After obtaining the peak values of the outermost ring, step 442 is performed wherein the controller 24 matches the data of the outermost ring for determining a center and radius through a mathematical approach. In one embodiment, the approach for matching the contour data can be, but should not be limited to, the least square method. FIG. 9 shows the matching result which illustrates the radius and center of the outermost fringe so that the size of the interference ring pattern representing the specific particle is obtained. When the radius and center of the interference ring pattern of the specific particle is determined, a step 443 is performed wherein the controller 24 determines the position along the vertical direction with respect to a specific particle according to the determined radius of the interference ring pattern, i.e., size of the interference ring pattern, and the vertical position information established in step 40. In addition, the controller 24 also determines the XY position according to the determined center of the interference ring pattern with respect to the specific particle. Accordingly, the tracking information, i.e., the three-dimensional position of the specific particle is determined.

On the other hand, in case of determining the velocity of the specific particle, it is necessary to have different images associated with different timing point. These images can be captured in the step 42 shown in FIG. 4 wherein the image capturing unit 23 captures first and second images respectively corresponding to different time points by controlling the shutter. For example, in case of consumer electronic camera, the shutter can be controlled to be ON status and at least two different color light fields generated form the light source, such as red light, blue light, and green light, for example, are sequentially projected on the sample fluid. The time period between each color light filed depends on the requirement of the user. After that, the controller 24 separates the at least two different color images, and determines a first vertical position associated with the specific particle according to the first color image, such as red color image, and determines a second vertical position associated with the specific particle according to the second color image such as blue color image. The determination procedures are the same as the aforesaid steps 440˜443. Once the first vertical position and second vertical positions are obtained, since the time period between the first and second vertical positions are already known, the controller 24 can determine the velocity according to the first and second position as well as the time period therebetween. It is also noted that when the images having interference ring pattern corresponding to the particles is obtained, the two-dimensional particle tracking on XY plane perpendicular to the optical axis of the objective can be obtained according to the known techniques. For example, for red color image, the center of the interference ring pattern of the specific particle is referred to the XY position at first time point, and for blue color image, the center of the same specific particle is referred to the XY position at second time point. Accordingly, the velocity of XY plane can be determined as well. Therefore, the three-dimensional particle tracking can be achieved. It is also noted that when there are three colors projected on the sample fluid, three-dimensional acceleration of the specific particle can be determined. For example, in the vertical direction, the red color image and blue color image can be utilized to determine the first velocity at first time point, and the blue color image and green color image can be utilized to determine the second velocity at second time point. According to first and second velocity at first time and second time points, the corresponding acceleration along the vertical direction can be determined. Likewise, the acceleration along the XY plane can be determined as well.

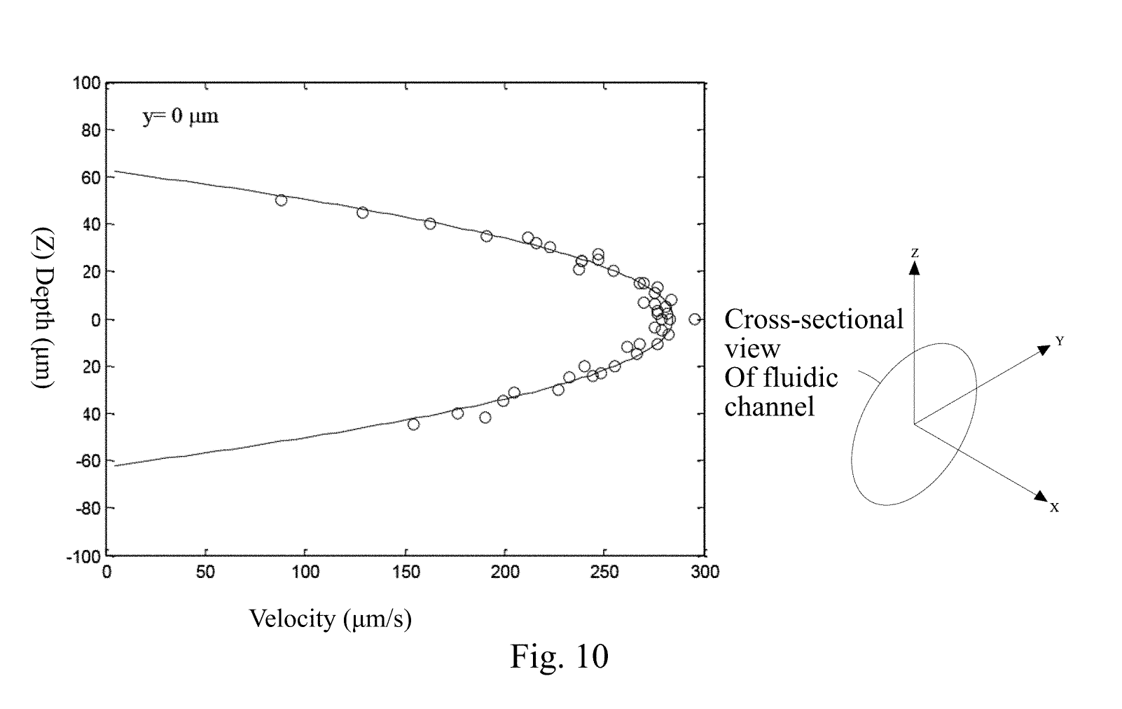

Please refer to FIG. 10, which illustrates the exact solution of the velocity distribution along vertical direction and experimental result of the velocity distribution along vertical direction (Z) of the fluidic channel as well as the cross-sectional view of the fluidic channel. The flow in the fluidic channel is a laminar flow and the cross-sectional shape is circular shape. The diameter of fluidic channel is 125 particle size is 1 μm and the volume flow rate is 0.1 μl/min. In FIG. 11, the horizontal axis represents the velocity (μm/s) along vertical direction and the vertical axis represents the vertical position (μm) along the vertical direction (Z). The curve represents the exact solution of the vertical velocity field when the Y position is 0 μm and the circle represents the experimental result of vertical velocity with respect to each particle located between −62.5 μm to 62.5 μm along vertical direction (Z). According to the result shown in FIG. 11, the experimental result obtained by the method and system of the present invention is very close to the exact solution.

For a single color image captured by the image capturing unit 23, the tracking particle density cannot be high, because the interference ring patterns respectively corresponding to different particles will interrupt with each other, thereby affecting the analyzing consequence. In addition, in order to prevent the interruption between two different interference ring patterns with high tracking particle density, in another alternative embodiment, it is capable of using sample fluid comprising a plurality of particles having at least one different kind of fluorescent colors whereby the tracking particle density can be increased in the sample fluid for obtaining more tracking information along the vertical direction. In this embodiment, the light source 20 projected on the particles can be visible light source or invisible light source, such UV light for exciting the fluorescent particles. In case of visible light, such as blue light, for example, one kind of particle can be non-fluorescent particle that can reflect the blue light while the other kind of particles can be fluorescent particles that can be excited by the blue light thereby generating at least one kind of a fluorescent color light different from the blue color. Alternatively, in case of invisible light, such as UV light, for example, the particles are fluorescent particles having at least two kinds of excited fluorescent colors when the UV light is projected on the fluorescent particles.

After the images captured by the image capturing unit, an image processing step for separating the particles having different fluorescent color or reflecting color is executed by the controller to obtain at least two images respectively corresponding to the at least two different kinds of fluorescent colors, or at least one fluorescent color and one reflecting color corresponding to the light color of light source. Each separated image has interference ring patterns with specific color. After that each image is performed by the steps 441 and 443 shown in FIG. 5 for acquiring the tracking information of each particle. It is also noted that at least two linear relationships respectively corresponding to different fluorescent color can be established for accurately acquiring the particle tracking along the vertical direction.

According to the abovementioned system and method for tracking the particle motion along vertical direction, it can have the merit that the dark-filed condenser lens in the present embodiments receives the incident light for generating a cone-shaped light filed projecting on the fluid sample without directly entering the objective lens, the image capturing unit can receive the scattered light field from the particles through the objective lens so as to obtain images having high S/R ratio.

While the present invention has been particularly shown and described with reference to a preferred embodiment, it will be understood by those skilled in the art that various changes in form and detail may be without departing from the spirit and scope of the present invention.

1. A particle tracking system, comprising:
a light source, configured to generate a light field;
a dark-field condenser, configured to receive the light field and project an off-axis light field on a fluid sample having at least one particle thereby generating a scattered light field associated with the at least one particle;
an objective lens, configured to receive the scattered light field;
an image capturing unit, configured to couple to the objective lens for receiving the scattered light field thereby generating at least one image corresponding to the scattered light field, wherein the scattered light field having an interference ring pattern corresponding to a specific particle having a distance far away from a reference plane that is a plane where the specific particle forms a non-interfered image on an image plane of the image capturing unit; and
a controller, configured to couple to the image capturing unit for analyzing the interference ring pattern corresponding to the specific particle in the at least one image and determining a tracking information associated with the specific particle along a vertical direction according to a size of the interference ring pattern.

2. The particle tracking system of claim 1, wherein the tracking information is a position along the vertical direction.

3. The particle tracking system of claim 2, wherein the controller comprises a linear relationship between sizes of the interference ring pattern and known positions along the vertical direction, and the controller determines the size of the interference ring pattern, and determines the position of the specific particle along the vertical direction according to the linear relationship.

4. The particle tracking system of claim 1, wherein the size of the interference ring pattern is determined according to an outermost interference ring of the interference ring pattern and for each interference ring pattern of each specific particle, the outermost interference ring is brighter than an inner interference ring of the interference ring pattern due to the off-axis light field projecting onto the specific particle.

5. The particle tracking system of claim 1, wherein the tracking information is a velocity along the vertical direction, wherein the image capturing unit acquires a first and a second images, and the controller determines a first vertical position associated with the specific particle according to the first image, determines a second vertical position associated with the specific particle according to the second image, and determines the velocity according to the first and second position.

6. The particle tracking system of claim 1, wherein the light source is a laser beam generator, or a LED light source.

7. The particle tracking system of claim 1, wherein the fluid sample comprises a plurality of particles with at least one kind of fluorescent color for increasing more tracking information along the vertical direction.

8. The particle tracking system of claim 7, wherein one image captured by the image capturing unit comprises at least two different kinds of colors, and the controller performs an image processing step to separate the different color thereby obtaining at least two separated images respectively corresponding to the at least two different kinds of colors, wherein each separated image has the interference ring patterns.

9. A method for tracking particle, comprising steps of:
providing a light field generated by a light source;
providing a dark-field condenser for receiving the light field and projecting an off-axis light field on a fluid sample having at least one particle thereby generating a scattered light field associated with the at least one particle;
receiving the scattered light field by an objective lens, wherein the scattered light field having an interference ring pattern corresponding to a specific particle having a distance far away from a reference plane that is a plane where the specific particle forms a non-interfered image on an image plane of the image capturing unit;
capturing at least one image corresponding to the scattered light field by an image capturing unit coupled to the objective lens; and
analyzing the interference ring pattern corresponding to the specific particle in the at least one image and determining a tracking information associated with the specific particle along a vertical direction according to a size of the interference ring pattern by a controller electrically coupled to the image capturing unit.

10. The method of claim 9, wherein the tracking information is a position along the vertical direction, and the controller comprises a linear relationship between sizes of the interference ring pattern and known positions along the vertical direction, wherein determining the tracking information further comprises steps of:
determining the size of the interference ring pattern of the specific particle; and
determining the position along the vertical direction of the specific particle according to the size of the interference ring pattern and the linear relationship.

11. The method of claim 10, wherein determining the size of the interference ring pattern further comprises steps of:
acquiring the interference ring pattern corresponding to the specific particle;
performing an image processing for constructing a contour of each bright ring of the interference ring pattern and calculating peak values of the contour; and
matching peak values of the contour for determining a center and radius of the interference ring pattern.

12. The method of claim 11, further comprising a step of determining a position information on a XY plane perpendicular to the vertical direction according to the center of the interference ring pattern.

13. The method of claim 9, wherein the tracking information is a velocity along the vertical direction, and the image capturing unit capturing a first and a second images, wherein determining the tracking information further comprises steps of:
determining a first vertical position associated with the specific particle according to the first image;
determining a second vertical position associated with the specific particle according to the second image; and
determining the velocity according to the first and second positions.

14. The method of claim 13, wherein the image capturing unit is a consumer electronic camera, and the first image and the second image are obtained by steps of switching a shutter of the consumer electronic camera at ON status, sequentially projecting two light fields having different color from each other on the sample fluid, and sensing a scattered light field corresponding to the two different light fields by the consumer electronic camera for generating the first and second images.

15. The method of claim 9, wherein the light source is a laser beam generator, or a LED light source.

16. The method of claim 10, wherein the linear relationship is established by steps of:
providing a fluidic channel prepared for accommodating the fluid sample;
arranging particle samples having known size on a top channel wall and a bottom channel wall inside the fluidic channel;
projecting the light field generated from the light source on the particle samples arranged on the top and bottom channel wall through the dark-field condenser;
capturing calibration images of the particle samples on the bottom and top channel walls;
analyzing the calibration images and determining the size of the interference ring patterns respectively corresponding to the particle samples on the top and bottom walls of the channel; and
establishing the linear relationship between the determined size of the particle samples on the top and bottom channel walls and a height of the fluidic channel.

17. The method of claim 16, further comprising a step of adjusting the power of the light source for increasing an intensity of the light field thereby increasing an inspection range of the vertical direction inside the fluidic channel.

18. The method of claim 9, wherein the size of the interference ring pattern is determined according to an outermost interference ring of the interference ring pattern and for each interference ring pattern of each specific particle, the outermost interference ring is brighter than an inner interference ring of the interference ring pattern due to the off-axis light field projecting onto the specific particle.

19. The method of claim 9, wherein the fluid sample comprises a plurality of particles with at least one kind of fluorescent color for increasing more tracking information along the vertical direction.

20. The method of claim 19, wherein one image captured by the image capturing unit comprises at least two different kinds of colors, and an image processing step is performed to separate the different color thereby obtaining at least two separated images respectively corresponding to the at least two different kinds of colors, wherein each separated image has the interference ring pattern.
